(19) United States
(12) Patent Application Publication
(10) Pub. No.: US 2017/0078900 A1
(43) Pub. Date: Mar. 16, 2017

(54) NETWORK PERFORMANCE DATA

(71) Applicant: NOKIA SOLUTIONS AND NETWORKS OY, Espoo (FI)

(72) Inventor: Vasily PROKOFIEV, Espoo (FI)

(21) Appl. No.: 15/121,954

(22) PCT Filed: Feb. 27, 2014
(86) PCT No.: PCT/EP2014/053869

§ 371 Date: Aug. 26, 2016

(51) Int. Cl. H04W 24/04; H04W 24/10; H04L 12/24

(52) U.S. Cl. CPC H04W 24/04; H04L 41/5009; H04L 41/0631; H04W 24/10; H04L 41/0816

(57) ABSTRACT

Network performance data is provided with at least two accuracy level: a general level with general data, used when there are no problems, and at least one detailed level with more detailed data, used when a problem is detected.

### FIELD

The present invention relates to network performance data.

### BACKGROUND

The following description of background art may include insights, discoveries, understandings or disclosures, or associations together with disclosures not known to the relevant art prior to the present invention but provided by the invention. Some such contributions of the invention may be specifically pointed out below, whereas other such contributions of the invention will be apparent from their context.

In recent years, the phenomenal growth of mobile Internet services and proliferation of smart phones and tablets has increased also the amount of network nodes. The more there are network nodes, the more there is data to be collected and transmitted to a network management system, since each network node is supposed to collect data reflecting network performance. For example data on user apparatuses registering to and de-registering from the network node is needed in the network management system. Further, to determine, correct or prevent a fault, it is not sufficient to monitor and report only one factor. This further increase the amount of data to be transmitted to the network management system that is turn has a lot of data to analyse.

### SUMMARY

A general aspect of the invention provides network performance data with at least two accuracy level: a general level with general data, used when there are no problems, and at least one detailed level with more detailed data, used when a problem is detected. Various aspects of the invention comprise methods, a computer program product, an apparatus and a system as defined in the independent claims. Further embodiments of the invention are disclosed in the dependent claims.

### BRIEF DESCRIPTION OF THE DRAWINGS

In the following, the invention will be described in greater detail by means of preferred embodiments with reference to the attached drawings, in which

FIG. 1 shows simplified architecture of a system and block diagrams of some apparatuses according to an exemplary embodiment;

FIGS. 2, 3 and 4 are flow charts illustrating exemplary functionalities; and

FIG. 5 is a schematic block diagram of an exemplary apparatus.

### DETAILED DESCRIPTION OF SOME EMBODIMENTS

The following embodiments are exemplary. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments.

Embodiments of the present invention are applicable to any network, a network element, a network node, a corresponding component, a corresponding apparatus and/or to any communication system or any combination of different communication systems. The communication system may be a wireless communication system or a fixed communication system or a communication system utilizing both fixed networks and wireless networks. The specifications of different systems and networks, especially in wireless communication, develop rapidly. Such development may require extra changes to an embodiment. Therefore, all words and expressions should be interpreted broadly and they are intended to illustrate, not to restrict, the embodiment.

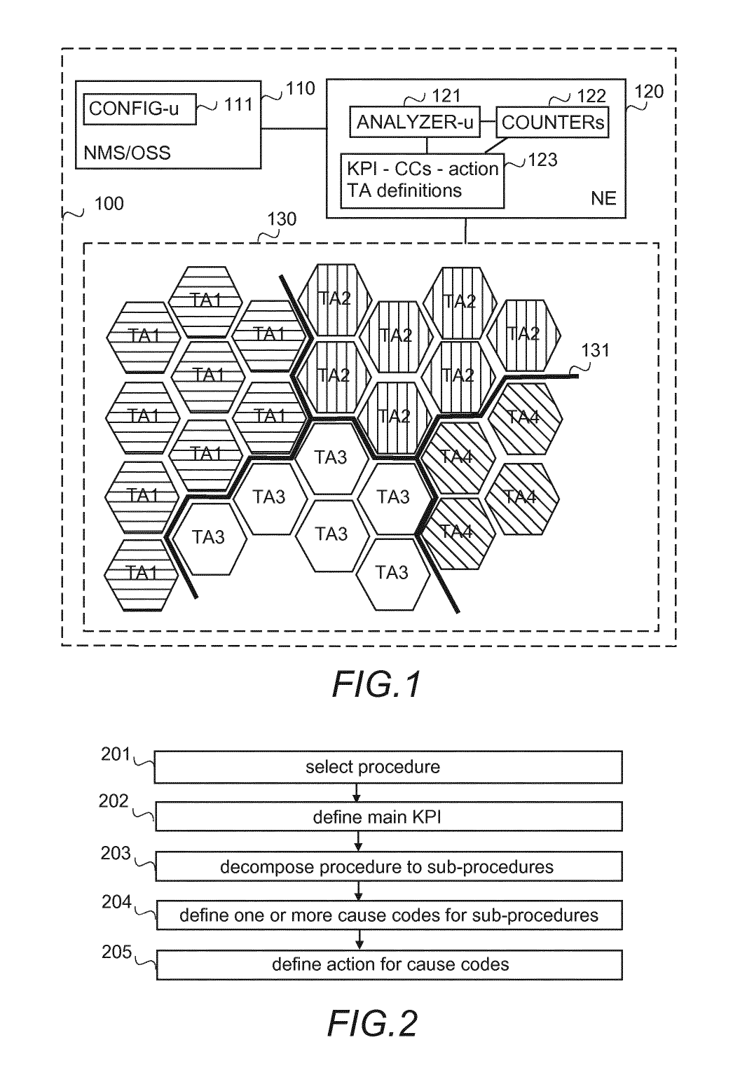

A general architecture of an exemplary system 100 is illustrated in FIG. 1. FIG. 1 is a simplified system architecture only showing some elements and functional entities, all being logical units whose implementation may differ from what is shown. It is apparent to a person skilled in the art that the system comprises other functions and structures that are not illustrated herein.

The exemplary system 100 illustrated in FIG. 1 comprises a network management system 110, a network element 120 in a core network or in a radio access network, and an area 130 in the radio access network which is served by the network element 120.

The network management system (NMS) 110 describes herein “network systems” dealing with a network itself, supporting processes such as maintaining network inventory, provisioning services, configuring network components, and managing faults, and hence covers herein different types and/or levels of network management, including an operational support system (OSS), and/or operation and maintenance system, and/or element management systems. In other words, how the management of the system or network is implemented bears no significance. Typically, but not necessarily, the network management comprises at least fault management, configuration management, and performance management. The fault management is used to detect immediate problems in a network through alarms. The configuration management is used to enable, disable or modify functionality across one or more network elements. The performance management is used to measure availability, capacity and quality of network services, for example. In the illustrated example NMS/OSS comprises one or more configuration units (CONFIG-u) 111 for configuring network elements 120 to provide data for alerts, automatic correction and/or for performance management, as will be described by means of examples in more detail below.

The network element (NE) 120 may be any computing apparatus that can be configured to provide performance data. Examples of such network elements in a core network (not illustrated in FIG. 1) include a mobility management entity (MME), a packet data network gateway (P-GW), and a serving-gateway (S-GW). Examples of such network elements in a radio access network include an eNodeB, other types of base stations, an access point and a cluster head in device-to-device sub-system. In order to provide the performance data the network element 120 comprises one or more analyzer units (ANALYZER-u) 121, one or more counters 122 and a memory 123 storing configuration data, or configuration settings, for example. Exemplary functionalities of the analyzer unit will be described in more detail below.

In the illustrated example the configuration data associate a key performance indicator (KPI) with one or more cause codes (CCs) which in turn may be associated with one or more action definitions. Examples of configuration data will be described below. Further, in the illustrated example the configuration data comprises one or more target area (TA) definitions, a target area defining one or more subsets of cells belonging to a service area of the network entity. A subset may comprise one or more cells, and if only one subset is defined, it may comprise all cells belonging to the service area. A target area defines area across which the measurement results are combined. A target area may also be called a measurement object. Although in the example the target area definitions are not associated with a key performance indicator, they may be given key performance indicator—specifically and/or cause code—specifically and/or one or more key performance indicators and/or cause codes may be associated with specific target area definitions whereas some others may share the same target area definitions. Further, it should appreciated that also cause codes, or some of them, may be shared by two or more key performance indicators, even by all key performance indicators.

The area 130 in the radio access network which is served by the network element 120 and depicted in FIG. 1 is divided into four different target areas TA1 (horizontal hatch), TA2 (vertical hatch), TA3 (no hatch), TA4 (diagonal hatch), separated in the FIG. 1 by a border line 131. The division to target areas allows a geographical segmentation to find out how the network service operates in different parts. Examples of radio access networks that may be divided into one or more target areas include networks include LTE (Long Term Evolution) access system, Worldwide Interoperability for Microwave Access (WiMAX), Wireless Local Area Network (WLAN), LTE Advanced (LTE-A), and beyond LTE-A, such as 5G (fifth generation).

FIG. 2 is a flow chart illustrating an exemplary functionality of the configuration unit. The functionality will be explained using the mobile management entity as an example of a network element for which the configuration is created, and attach procedure as an example of a procedure for which the configuration data is created without restricting implementations and functionality to such an example; the mere purpose of the example is to illustrate the functionality.

Referring to FIG. 2, a procedure for which the settings (configuration data) are created is first selected in step 201. The selection may include also selection for the network element performing the procedure. An attach procedure of a user equipment may be seen differently by an eNodeB than by the mobility management entity, and hence facilitates providing the network with complex and content-based integrated diagnostic for each particular case.

Then one or more main key performance indicators for the process are defined in step 202. In the example, for the attach procedure a key performance indicator is a success rate indicating how many of the attach attempts success. When all attach attempts are successful, the success rate is 1 (or 100%). The selected procedure is decomposed (broken down) in step 203 to one or more sub-procedures, different sub-procedures encapsulating logically independents logic blocks. The attach procedure controlled/monitored by the mobility management entity in an evolved packet system (EPS) providing a core network system for LTE-advanced radio access, for example, may be decomposed to 9 different sub-procedures.

In the example one or more cause codes (CC) are defined in step 204 for each sub-procedure. However, it should be appreciated that a sub-procedure may share a common cause code with another sub-procedure and hence one or more cause codes may be determined for two or more sub-procedures. Then for each cause code or for a combination of one or more cause codes, one or more actions and/or conclusions are defined in step 205, and the configuration data for that procedure in the network element has been defined.

The configuration unit may be configured to send the configuration data to the element in question and/or store it to the network management system.

Following table illustrates some of the configuration data in the example of attach procedure and the network element being a mobile management entity. The success rate, i.e. the main key performance indicator is calculated using the counter values for cause codes 1 and 16, more precisely by dividing CC16/CC1. In the illustrated example, it is assumed, for the sake of clarity that the action is for all case codes the same, send information to NMS.

| Sub-procedure | CC# | NAME/Definition |
|---|---|---|
| Attach Attempt | 1 | EPS_ATTACH_ATTEMPT |
| | | The number of attempted attach procedures initiated |
| | | by UEs (user equipments) within the target area. For |
| | | example, the corresponding counter may calculate |
| | | the number of “Attach Request” messages. |
| | | Does not count retransmissions, but counted every |
| | | time when procedure initiated for a subscriber. |
| Security Failures | 2 | EPS_ATTACH_AKA_FAIL |
| | | The number of failed procedures because of error |
| | | indication during AKA (authentication and key |
| | | agreement procedure, including all AKA failures but |
| | | not including HSS (home subscriber server) failures. |
| | | Includes also Identity request cases. For example, |
| | | the corresponding counter may calculate the number |
| | | of “Identity response” messages. |
| | 3 | EPS_ATTACH_SMC_FAIL |
| | | The number of failed procedures because of all error |
| | | indication during SMC (security mode command) |
| | | procedure and the number of failed procedures because |
| | | security algorithm not supported by UE. For |
| | | example, the corresponding counter may calculate |
| | | the number of “Authentication” messages indicating |
| | | fail. |
| | 4 | EPS_ATTACH_UE_SEC_UNSUPP_FAIL |
| | | The number of failed procedures because security |
| | | algorithm not supported by UE. For example, the |
| | | corresponding counter may calculate the number of |
| | | “Security” messages indicating fail. |
| HSS Related Failures | 5 | EPS_ATTACH_HSS_RESTRIC_FAIL |
| | | The number of failed procedures because of HSS |
| | | (home subscriber server) access restriction with Update- |
| | | Location-Answer (Update location answer from |
| | | HSS containing accessRestrictionData with - |
| | | eutranNotAflowed). |
| | 6 | EPS_ATTACH_LOCAL_NO_ROAM_FAIL |
| | | The number of failed IMSI (international mobile subscriber |
| | | identifier) analyzes procedures, including |
| | | cases when PLMN (public land mobile network) configuration |
| | | does not allow the roaming. |
| | 7 | EPS_ATTACH_HSS_NO_ROAM_FAIL |
| | | The number of failed procedures because of HSS |
| | | restriction (no roaming allowed) with Update- |
| | | Location-Answer. |
| | 8 | EPS_ATTACH_HSS_NO_RESPONSE_FAIL |
| | | No response from HSS during Authentication Information |
| | | Answer, including transport errors equivalent |
| | | to No Response case. |
| EIR Related Failures | 9 | EPS_ATTACH_EIR_NO_RESP_FAIL |
| | | The number of failed procedures because EIR |
| | | (equipment identity register) did not respond. |
| | 10 | EPS_ATTACH_IMEI_BLOCKED_FAIL |
| | | The number of failed procedures because IMEI (international |
| | | mobile equipment identity) is blocked. |
| DNS Failures | 11 | EPS_ATTACH_DNS_NO_NAME_FOUND_FAIL |
| | | The number of failed procedures because name is |
| | | not found on DNS (domain name server), including |
| | | failure on deriving S-GW and/or P-GW address. It |
| | | further includes no response cases. |
| GW Failures | 12 | EPS_ATTACH_GW_CRE_SESS_FAIL |
| | | The number of failed procedures because of failure |
| | | from GW (gateway) in Create Session Response. |
| | 13 | EPS_ATTACH_GW_MD_BEARER_FAIL |
| | | The number of failed procedures indicated in “Modify |
| | | Bearer Response” from GW. |
| ENB Failures | 14 | EPS_ATTACH_INIT_CNTX_FAIL |
| | | The number of failed procedures because no response |
| | | to Initial Context Setup Request. |
| UE Failures | 15 | EPS_ATTACH_UE_NOT_COMPLETE_FAIL |
| | | The number of failed procedures because Attach not |
| | | completed by UE. |
| | | For example, UE didn't respond with Attach_Complete |
| | | message within a given period so |
| | | attach procedure is considered to fail. |
| Attach Success | 16 | EPS_ATTACH_SUCC |
| | | The number of success Attach procedures. |

Although in the above examples it is assumed that the selected procedure is decomposed to a sub-procedure and no further decomposition is performed, it should be appreciated that a sub-procedure, or sub-procedure function, may further be decomposed to its sub-procedures, etc., depending how complex the selected procedure is. When a sub-procedure is decomposed, it is treated like the selected procedure above, i.e. one or more key performance indicators, and one or more other cause codes may be defined it. In other words, a nested process structure with nested main key performance indicators and nested cause codes may be created.

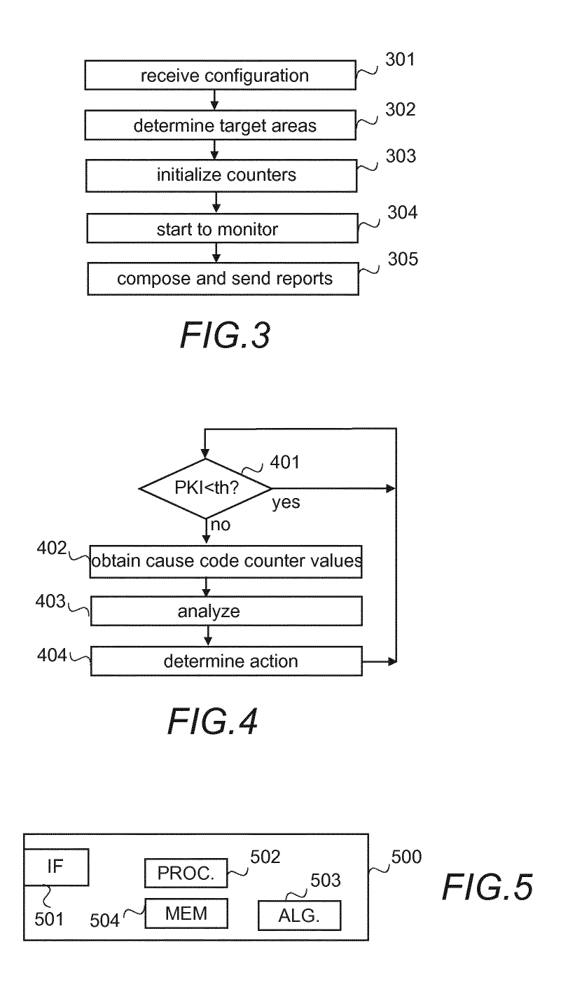

FIG. 3 illustrates an exemplary functionality in a network element responsible for collecting the data. More precisely, it illustrated functionality of an analyzer unit.

When the network element receives in step 301 the configuration (or settings) from the network management system, it determines one or more target areas in step 302 and initializes in step 303 counters for the target areas. The target areas may be procedurespecific or common to all procedures or any combination of specific and common. Further, it should be appreciated that in some other implementations the network management system may determine the target areas, in which case they may be sent to the network element as part of the configuration and/or separately, and the network element determines the target areas based on the received information. Then the network entity starts in step 304 to monifor the network behavior according to the received configuration, and in step 305 creates and sends reports to the network management system either as instructed in the received configuration settings, or by another message from the network management system or as preconfigured to the network element.

FIG. 4 illustrates an exemplary functionality of the network element, or more precisely the analyzer unit, when the network element performs the monitoring for a main key performance indicator. It should be appreciated that several parallel processes may be run by the analyzer unit.

Referring to FIG. 4, as long as a value of the key performance indicator (KPI) is smaller than a threshold value (th), monitoring of the key performance indicator in step 401 is continued, and reports indicating the value are sent. The threshold value may be submitted with the configuration (for example, determined by the network management system as part of the configuration described above with FIG. 2), either as key performance indicator specific value or as a value common or shared by some key performance indicators, or the threshold value may be preconfigured to the network element.

For example, to the above described attach procedure and four target areas in step 401 it is actually monitored whether CC16/CC1 stays above a threshold which may be 99%, for example, and as long PKI remains above it (i.e. is within a predefined or preset range of 99% to 100%), the value of CC16/CC1 and/or the counter values are reported to the network management system. Depending on an implementation, the report may contain the values target area—specifically or as an average or a median of the values, or in any other form the network element is configured to provide the responses. In other words, a general level of network performance data is transmitted.

When the value in the target area drops below the threshold (step 401), also counter values for those cause codes that are not monitored in step 401, are obtained in step 402, analyzed in step 403 to find out one or more cause codes causing the service failure, and based on the cause codes indicating where the problem may be one or more actions are determined in step 404. Using the example above, values of cause codes CC2 to CC15 are obtained, analyzed and one or more actions are determined. Examples of actions are described below. Depending on an implementation, the values of all cause codes or the value(s) of cause code(s) indicating the reason for KPI dropping below the threshold are reported to the network management system. In other words, a more detailed level of network performance data is transmitted.

Although in the above examples the threshold used has been an exact value above which KPI is when the network behavior is acceptable, the threshold may be given as a range within which KPI should be or within which KPI should not be, or the threshold value may be a value below which KPI should be. Further, instead an exact value, approximate values may be used.

At the simplest the action may be: “ignore the problem”. For example, if the problem is caused by roaming user equipments not allowed to roam (CC6 in the above table), the problem is not caused by the network, and hence it can be ignored. Other examples of actions include “send an alert to the network management system”, or “send in the report to the network management system the cause codes indicating problem(s) and their values”, or “send all cause code values to the network management system”. However, an action may be a more complicated action trying locally to solve the problem or trying locally to more clearly find out what causes the problem, in which case the action may be to further divide the target area to smaller target areas, initialize counters and repeat steps 402 to 404 for these new smaller target areas. For example, if the problem is that user equipments do not respond within a time period they are supposed to respond (CC15 in the above table), it may that during the procedure focused to the smaller target areas, one cell is found to cause the problems. Then the reason may be determined automatically be checking certain features that may be defined as a sub-action, possible including a repair action. For example, if during a cell resizing of the cell to a larger cell, the time period is not updated, a repair action is to update the time period (or trigger a corresponding procedure).

Other examples on actions, using the table disclosed above, are:
KPI drops below 99% in TA1, values of cause code counters indicate that CC3 and CC4 are responsible for KPI dropping below the threshold, the analyzer unit provides automatic suggestion for an action correcting the situation: enable certain security algorithm for the network element (mobile management entity).
KPI drops below 99% in TA2, values of cause code counters indicate that CC11 is responsible for KPI dropping below the threshold, the analyzer unit provides automatic suggestion for an action correcting the situation: check a network path for the problematic name, the path check including for example at least the following: check network routing configuration check, physical path availability check, and possible overload on the path(s).
KPI drops below 99% in TA4, values of cause code counters indicate that CC12 is responsible for KPI dropping below the threshold, the analyzer unit provides automatic suggestion for an action correcting the situation: check network configuration for the problematic S-GW.

As is evident from the above examples, the network element may be configured, by defining a corresponding action (or action point), to resolve a problem, at least for most typical cases. This in turns prevents service degradation, reduces operation costs and decrease reaction time for service recovery.

Although not explicitly said above, it is evident that the monitoring is performed using counter values collected over a certain time period, which may a system value or a network element specific value, either preset/hardcoded or updatable by the network management system, for example.

As is evident from the above, what is monitored, on what raster (i.e. the size of the target areas) and what is reported, or what actions are performed automatically, i.e. by the system without user involvement, are easily updated whenever need arise.

The above described collecting of network performance data, resulting to different amounts of performance data transmitted to the network management system may be called an adaptive performance data. Compared to a conventional solution in which certain amount of performance data is collected, the adaptive performance data overcomes, or at least partly solves, a dilemma: more detailed information uses network resources and analyzing resources but a general level of information is not sufficient to solve problematic situations. For example, if a network comprises 100 000 target areas, and the above attach procedure is used as an example with assumed failure rate 5%, and it is assumed that instead of reporting the success rate, corresponding counter values are reported, possible performance scenarios are following:
conventional solution sending only values of counters CC1 and CC16:
   number of counter values transmitted 200 000 (100 000 target areas, two counters per target area)
conventional solution sending values of counters CC1 to CC16
   number of counter values transmitted 1 600 000 (100 000 target areas, 16 counters per target area)
the above described adaptive solution sending values of counters CC1 and CC16 from target areas without problems and values from counters CC1 to CC16 from the problematic target areas
   number of counter values transmitted 240 000 (0.95*100 000 target areas sending 2 counter values, 0.05*100 000 target areas sending 16 counter values)

As can be seen from the above example, the amount of performance data transmitted in the adaptive solution remains compact but still provides mathematically complete detailed data, collected with guaranteed granularity and precision, on problematic target areas, there is no losing precision or granularity in favor of data volume. This is a valuable feature especially for heterogeneous networks that increase complexity of interaction scenarios, such as interactions between different radio access technologies (GSM, LTE, CDMA, WiFi etc.) to ensure that an end user can smoothly roam between the different technologies. Complexity of those scenarios derives some sort of “combinatory burst”, derived numerous of possible causes for each fault. Thus, collecting of bigger volumes of data is mandatory without losing it's precision and granularity, and the adaptive solution facilitates to minimize the size of the bigger volumes.

Further, the information transmitted in the adaptive solution takes into account the failure rate.

The steps and related functions described above in FIGS. 2, 3 and 4 are in no absolute chronological order, and some of the steps may be performed simultaneously or in an order differing from the given one. For example, if nested KPIs are used, a step corresponding to step 401 may be performed for each nested KPI (on the same sub-procedure level) after step 402, which in turn may trigger simultaneous processing. Other functions can also be executed between the steps or within the steps. For example, KPI may be provided with two or more thresholds triggering a little bit different analyzing and detailed information collecting. Some of the steps or part of the steps can also be left out or replaced by a corresponding step or part of the step/message. For example, in an implementation in which the analysing of problematic situations is performed in the network management system, steps 402 and 403 may be skipped over, and the values of cause code counters may be sent after they are obtained. Another example is that a standalone network element may be configured to perform initial analysis and possibly also dynamic pre-qualification of the problems and then to use external (additional) computation resources in a cloud environment to collect and/or analyze extra information elements or counters. Yet another example is to initialize only counters needed for KPI(s), and the rest only after the values are needed for detailed analysis.

FIG. 5 is a simplified block diagram illustrating some units for an apparatus 500 configured to configure the monitoring apparatus or to be the monitoring apparatus, i.e. an apparatus providing at least the configuration unit and/or an analyzer unit, and/or counters and/or one or more units configured to implement at least some of the functionalities described above. In the illustrated example, the apparatus comprises one or more interfaces (IF) 501 for receiving and transmitting information over interface(s), a processor 502 configured to implement at least some functionality, including counter functionality, described above with corresponding algorithm/algorithms 503, and memory 504 usable for storing a program code required at least for the implemented functionality and the algorithms. The memory 504 is also usable for storing other information, like the configuration settings.

In other words, the apparatus is a computing device that may be any apparatus or device or equipment configured to perform one or more of corresponding apparatus functionalities described with an embodiment/example/implementation, and it may be configured to perform functionalities from different embodiments/examples/implementations. The unit(s) described with an apparatus may be divided into sub-units, like the analyzer unit to a monitoring unit and configuration setting unit, for example, or be separate units, even located in another physical apparatus, the distributed physical apparatuses forming one logical apparatus providing the functionality, or integrated to another unit or to each other in the same apparatus. Hence, the implementation of the units and/or one of the units may utilize cloud deployment. For example, the analyzer unit functionality described above performed by the network element may be distributed to a cloud environment.

The techniques described herein may be implemented by various means so that an apparatus implementing one or more functions of a corresponding apparatus described with an embodiment/example/implementation comprises not only prior art means, but also means for implementing the one or more functions of a corresponding apparatus described with an embodiment and it may comprise separate means for each separate function, or means may be configured to perform two or more functions. For example, the configuration unit and/or an analyzer unit, and/or the counters, and/or algorithms, may be software and/or software-hardware and/or hardware and/or firmware components (recorded indelibly on a medium such as read-only-memory or embodied in hard-wired computer circuitry) or combinations thereof. Software codes may be stored in any suitable, processor/computer-readable data storage medium(s) or memory unit(s) or article(s) of manufacture and executed by one or more processors/computers, hardware (one or more apparatuses), firmware (one or more apparatuses), software (one or more modules), or combinations thereof. For a firmware or software, implementation can be through modules (e.g., procedures, functions, and so on) that perform the functions described herein. Software codes may be stored in any suitable, processor/computer-readable data storage medium(s) or memory unit(s) or article(s) of manufacture and executed by one or more processors/computers.

The apparatus may generally include a processor, controller, control unit, microcontroller, or the like connected to a memory and to various interfaces of the apparatus. Generally the processor is a central processing unit, but the processor may be an additional operation processor. Each or some or one of the units and/or counters and/or algorithms described herein may be configured as a computer or a processor, or a microprocessor, such as a single-chip computer element, or as a chipset, including at least a memory for providing storage area used for arithmetic operation and an operation processor for executing the arithmetic operation. Each or some or one of the units and/or counters and/or algorithms described above may comprise one or more computer processors, application-specific integrated circuits (ASIC), digital signal processors (DSP), digital signal processing devices (DSPD), programmable logic devices (PLD), field-programmable gate arrays (FPGA), and/or other hardware components that have been programmed in such a way to carry out one or more functions of one or more embodiments/implementations/examples. In other words, each or some or one of the units and/or counters and/or the algorithms described above may be an element that comprises one or more arithmetic logic units, a number of special registers and control circuits.

Further, the apparatus may generally include volatile and/or non-volatile memory, for example EEPROM, ROM, PROM, RAM, DRAM, SRAM, double floating-gate field effect transistor, firmware, programmable logic, etc. and typically store content, data, or the like. The memory or memories may be of any type (different from each other), have any possible storage structure and, if required, being managed by any database management system. The memory may also store computer program code such as software applications (for example, for one or more of the units/counters/algorithms) or operating systems, information, data, content, or the like for the processor to perform steps associated with operation of the apparatus in accordance with examples/embodiments. The memory, or part of it, may be, for example, random access memory, a hard drive, or other fixed data memory or storage device implemented within the processor/apparatus or external to the processor/apparatus in which case it can be communicatively coupled to the processor/network node via various means as is known in the art. An example of an external memory includes a removable memory detachably connected to the apparatus.

The apparatus may generally comprise different interface units, such as one or more receiving units for receiving control information, requests and responses, for example, and one or more sending units for sending control information, responses and requests, for example. The receiving unit and the transmitting unit each provides an interface in an apparatus, the interface including a transmitter and/or a receiver or any other means for receiving and/or transmitting information, and performing necessary functions so that the network management related information, etc. can be received and/or sent. The receiving and sending units may comprise a set of antennas, the number of which is not limited to any particular number.

Further, the apparatus may comprise other units, such as one or more user interfaces for receiving user inputs, for example for the configuration, and/or outputting information to the user, for example different alerts an performance information.

It will be obvious to a person skilled in the art that, as technology advances, the inventive concept can be implemented in various ways. The invention and its embodiments are not limited to the examples described above but may vary within the scope of the claims.

1.-18. (canceled)

19. A computer implemented method comprising:
collecting, by means of counters, network performance data across a target area comprising two or more cells;
monitoring, by an apparatus, whether or not a value of at least one main key performance indicator remains within a range that provides required network performance, the value of the at least one main key performance indicator being obtained by using values of one or more specific counters making up the at least one main key performance indicator and forming a subset of the counters;
if the value of the at least one main key performance indicator does not remain within the range, obtaining, by the apparatus, values of the counters to determine, by the apparatus, one or more causes decreasing the network performance;
in response to a determined cause having a cause code that is associated with an action definition to further divide the target area into smaller target areas that are geographical parts of the target area, the smaller target area comprising one or more cells and forming a target area that is geographically smaller than the target area divided, dividing, by the apparatus, the target area to smaller target areas, initializing counters for the smaller target areas and repeating the collecting, monitoring, obtaining and dividing for new smaller target areas target-area specifically until a small enough target area to find out what causes decrease in the network performance is reached.

20. The method of claim 19, further comprising:
analysing the obtained values and related counters to determine the one or more causes.

21. The method of claim 20, further comprising:
determining an action to be performed to resolve a problem indicated by at least one of the one or more causes.

22. The method of claim 19, further comprising:
reporting network performance to a network management by sending the value of the at least one main key performance indicator obtained by using values of one or more specific counters making up the at least one main key performance indicator and forming a subset of the counters and/or the values of the specific counters making up the at least one main key performance indicator and forming a subset of the counters when the value of the at least one main key performance indicator remains within the range;
reporting the network performance to the network management by sending the obtained values of the counters when the value of the at least one main key performance indicator obtained by using values of one or more specific counters making up the at least one main key performance indicator and forming a subset of the counters does not remain within the range.

23. The method of claim 19, further comprising
receiving, as a configuration settings, at least one of information defining the main key performance indicator, information defining the counters and one or more actions to be performed;
updating the configuration correspondingly; and
starting to use the updated settings.

24. The method of claim 19, wherein the value of the at least one main key performance indicator obtained by using values of one or more specific counters making up the at least one main key performance indicator and forming a subset of the counters remains within the range when the value is above a threshold.

25. A computer implemented method comprising:
selecting a network procedure;
dividing, by an apparatus, the network procedure to two or more sub-procedure, each sub-procedure encapsulating logically independent logic blocks of the network procedure;
determining, by the apparatus, one or more cause code counters for sub-procedures;
determining, by the apparatus, at least one main key performance indicator for the procedure, obtainable by means of at least one cause code counter amongst the one or more cause code counters;
dividing, by the apparatus, at least one of the sub-procedures to two or more further sub-procedures;
repeating, by the apparatus, at least the determining steps to the two or more further sub-procedures;
associating one or more cause codes with an action definition to further divide a target area, which is an area across which network performance data is collected by means of cause code counters, into smaller target areas that are geographical parts of the target area, the smaller target area comprising one or more cells and forming a target area that is geographically smaller than the target area divided; and
using the at least one main key performance indicator, the one or more cause code counters and the action definition to configure a network element to collect network performance related data.

26. The method of claim 25, further comprising:
determining one or more further actions to be performed to resolve a problem indicated by at least one cause code counter; and
associating one or more cause codes with at least one of the one or more further actions.

27. The method of claim 25, further comprising:
determining a type of the network element; and
wherein the method is performed for the determined type of the network element.

28. An apparatus comprising:
at least one processor; and
at least one memory including computer program code;
wherein the at least one memory and the computer program code are configured to, with the at least one processor:
collect, by means of counters, network performance data across a target area comprising two or more cells;
monitor whether or not a value of at least one main key performance indicator remains within a range that provides required network performance, the value of the at least one main key performance indicator being obtained by using values of one or more specific counters forming a subset of the counters;
obtain, in response to the value of the at least one main key performance indicator not remaining within the range, values of the counters to determine one or more causes decreasing the network performance;
divide, in response to a determined cause code that is associated with an action definition to further divide the target area into smaller target areas that are geographical parts of the target area, the smaller target area comprising one or more cells and forming a target area that is geographically smaller than the target area divided, the target area to smaller target areas, initialize counters for the smaller target areas and repeat the collecting, monitoring, obtaining and dividing for new smaller target areas target-area specifically until a small enough target area to find out what causes decrease in the network performance is reached.

29. An apparatus comprising at least:
at least one processor; and
at least one memory including computer program code;
wherein the at least one memory and the computer program code are configured to, with the at least one processor:
divide a selected network procedure to two or more sub-procedure each sub-procedure encapsulating logically independent logic blocks of the network procedure;
determine one or more cause code counters for sub-procedures;
determine at least one main key performance indicator for the procedure, obtainable by means of at least one cause code counter amongst the one or more cause code counters;
divide at least one of the sub-procedures to two or more further sub-procedures, and determine one or more cause code counters and at least one main key performance indicator to the two or more further sub-procedures;
associate one or more cause codes with an action definition to further divide a target area, which is an area across which network performance data is collected by means of cause code counters, into smaller target areas that are geographical parts of the target area, the smaller target area comprising one or more cells and forming a target area that is geographically smaller than the target area divided; and
use the at least one main key performance indicator, the one or more cause code counters and the action definition to configure a network element to collect network performance related data.

30. The apparatus of claim 28, wherein the apparatus is configured to be a mobility management entity.

31. A non-transitory computer-readable medium having instructions stored thereon that are executable by a computing device to perform operations comprising:
collecting, by means of counters, network performance data across a target area comprising two or more cells;
monitoring, whether or not a value of at least one main key performance indicator remains within a range that provides required network performance, the value of the at least one main key performance indicator being obtained by using values of one or more specific counters making up the at least one main key performance indicator and forming a subset of the counters;
obtaining, when the value of the at least one main key performance indicator does not remain within the range, values of the counters to determine, by the apparatus, one or more causes decreasing the network performance;
in response to a determined cause having a cause code that is associated with an action definition to further divide the target area into smaller target areas that are geographical parts of the target area, the smaller target area comprising one or more cells and forming a target area that is geographically smaller than the target area divided, dividing, by the apparatus, the target area to smaller target areas, initializing counters for the smaller target areas and repeating the collecting, monitoring, obtaining and dividing for new smaller target areas target-area specifically until a small enough target area to find out what causes decrease in the network performance is reached.

32. A non-transitory computer-readable medium having instructions stored thereon that are executable by a computing device to perform operations comprising:
selecting a network procedure;
dividing the network procedure to two or more sub-procedure, each sub-procedure encapsulating logically independent logic blocks of the network procedure;
determining one or more cause code counters for sub-procedures;
determining, by the apparatus, at least one main key performance indicator for the procedure, obtainable by means of at least one cause code counter amongst the one or more cause code counters;
dividing, by the apparatus, at least one of the sub-procedures to two or more further sub-procedures;
repeating, by the apparatus, at least the determining steps to the two or more further sub-procedures;
associating one or more cause codes with an action definition to further divide a target area, which is an area across which network performance data is collected by means of cause code counters, into smaller target areas that are geographical parts of the target area, the smaller target area comprising one or more cells and forming a target area that is geographically smaller than the target area divided; and
using the at least one main key performance indicator, the one or more cause code counters and the action definition to configure a network element to collect network performance related data.

33. The non-transitory computer-readable medium of claim 32, wherein the operations further comprise determining a type of the network element, wherein the operations are performed for the type of the network element.

34. The method of claim 26, further comprising:
determining a type of the network element; and
wherein the method is performed for the determined type of the network element.
